(19) United States
(12) Patent Application Publication
(10) Pub. No.: US 2008/0017827 A1
(43) Pub. Date: Jan. 24, 2008

(54) HEAT TRANSFER MEDIUM COMPOSITION

(75) Inventors: Naoshi Ito, Gifu (JP); Kouichi Shikano, Gifu (JP)

Correspondence Address: CANTOR COLBURN, LLP, 55 GRIFFIN ROAD SOUTH, BLOOMFIELD, CT, 06002, US

(73) Assignee: SHISHIAI-KABUSHIKIGAISHA, Gifu (JP)

(21) Appl. No.: 11/841,222

(22) Filed: Aug. 20, 2007

Related U.S. Application Data
(63) Continuation-in-part of application No. PCT/JP2005/002624, filed on Feb. 18, 2005.

(51) Int. Cl. C09K 5/04

(52) U.S. Cl. 252/68

(57) ABSTRACT

The present invention relates to a heat transfer medium composition providing high thermal conductivity by maintaining stable dispersion of metal and/or metal oxide particles in heat transfer media. The heat transfer medium composition contains as its main component water, alcohol, glycol or glycol ether, further containing: (a) metal and/or metal oxide particles whose average diameter is 0.001 to 0.1 μm; (b) at least one kind of polyphosphonic acid having three or more phosphono groups per molecule and/or salts thereof; and (c) at least one kind of metal corrosion inhibitor.

### TECHNICAL FIELD

The present invention relates to a heat transfer medium composition to be used in coolant for internal combustion engines and motors, in heat transfer media for hot water suppliers, heaters, coolers and freezers, and in heat transfer media for snow melting and road heating systems. In particular, the present invention relates to a heat transfer medium composition which provides high thermal conductivity by providing stable metal and/or metal oxide particle dispersion in such fluids.

### BACKGROUND TECHNOLOGY

Heat transfer media including water or glycol such as ethylene glycol as a main component have been conventionally used as coolant for internal combustion engines and motors, as heat media for hot water suppliers, heaters, coolers and freezers, and as heat media for snow melting and road heating systems.

Heat exchange properties of these heat transfer media are dominated by the specific heat and thermal conductivity of the water or glycol used as main component. Such heat transfer media do not necessarily provide satisfactory heat exchange performances as they cannot satisfactorily accommodate themselves for elevating system temperature, downsizing of heat-exchangers and severe operation conditions.

In order to compensate for the lack of the aforementioned heat transfer performance, metal or metal oxide fine particles having high thermal conductivity are blended in heat transfer media (Transaction of the ASME, Journal of Heat Transfer 121, pp. 280-289, 1999).

The document reports that solutions where nano sized alumina or copper particles are dispersed in water or ethylene glycol exhibit higher thermal conductivity than solutions containing no such particles.

Another document reports that higher thermal conductivity can be attained with water-alumina particle solutions and water-titanium oxides particle solutions (Alternation of Thermal Conductivity and Viscosity of liquid by Dispersing Ultra-fine-Particles; Netsu Bussei 7 [4], 1993, pp. 227-233).

The fine particles of alumina and copper represented in those documents are prepared by a pulverization method with a ball mill, or a jet pulverizer, or a synthesizing method such as the evaporation condensation method or chemical deposition method. Such fine particles show better dispersion in a solvent such as water than micrometric or larger particles. Therefore, dispersion of these fine particles in a solvent (heat transfer medium) by a small amount exerts such effect that the thermal conductivity of the heat transfer medium itself can be enhanced.

### DISCLOSURE OF THE INVENTION

### Object of the Invention

A variety of corrosion inhibitors are blended in conventional heat transfer media in order to inhibit corrosion of metal parts used in cooling systems, and ionized in heat transfer media. Electrically charged metal and/or metal oxide fine particles chemically react with such ionized metal corrosion inhibitors and form precipitation and suspension, deteriorating thermal conductivity of heat media.

Accordingly, it is an object of the present invention to provide a heat transfer medium composition to provide heat transfer media having high thermal conductivity by maintaining stable dispersion of metal and/or metal oxide fine particles in heat transfer media.

### Means to Attain the Object

The present invention provides a heat transfer media composition to attain the above object of the present invention, comprising water, alcohol, glycol or glycol ether as its main ingredient, further comprising:

(a) one kind or two or more kinds selected from metal and/or metal oxide particles whose average diameter is 0.001 to 0.1 μm;

(b) at least one kind of polyphosphonic acid having at least three phosphono groups per molecule and/or salts thereof; and

(c) at least one kind of metal corrosion inhibitor.

The heat medium composition of the present invention contains at least one of polyphosphonic acid having at least three phosphono groups per molecule and/or salts thereof and inhibits chemical reaction between ingredients “a” and “c” above, thus preventing generation of precipitation and suspension, and retaining ingredient “a” stably dispersed in heat media where the composition is used.

### EFFECTS OF THE INVENTION

A heat transfer medium composition of the present invention comprising water, alcohol, glycol or glycol ether as its main ingredient, further comprises: (a) one kind or two or more kinds selected from metal and/or metal oxide particles whose average diameter is 0.001 to 0.1 μm; (b) at least one kind of polyphosphonic acid having at least three phosphono groups per molecule and salts thereof; and (c) at least one kind of metal corrosion inhibitor. The heat medium composition containing at least one kind of polyphosphonic acid having at least three phosphono groups per molecule and/or salts thereof inhibits chemical reaction between ingredients “a” and “c” above, thus preventing generation of precipitation and suspension, and retaining ingredient “a” stably dispersed in heat media where the composition is used over an extended period of time.

Accordingly, the heat transfer medium composition of the present invention provides excellent coolant for internal combustion engines and motors, excellent heat transfer medium for hot water suppliers, heaters, coolers and freezers, and excellent heat transfer medium for snow melting and road heating systems.

### BEST MODE FOR CARRYING OUT THE INVENTION

The heat medium composition of the present invention is described in greater detail hereunder. Its main ingredient is water, alcohol, glycol or glycol ether.

The alcohol may be selected from methanol, ethanol, propanol, butanol, pentanol, hexanol, heptanol, octanol and their blends.

The glycol may be selected from ethylene glycol, diethylene glycol, triethylene glycol, propylene glycol, 1,3-propanediol, 1,3-butanediol, 1,5-pentanediol, hexylene glycol and their blends.

The glycol ether may be selected from ethylene glycol monomethylether, diethylene glycol monomethylether, triethylene glycol monomethylether, tetraethylene glycol monomethylether, ethylene glycol monoethylether, diethylene glycol monoethylether, triethylene glycol monoethylether, tetraethylene glycol monoethylether, ethylene glycol monobutylether, diethylene glycol monobutylether, triethylene glycol monobutylether, tetraethylene glycol monobutylether and their blends.

Among the above main ingredients, ethylene glycol and propylene glycol are preferred for easiness of handling, favorable prices and ready availability.

Besides the main ingredient, the composition of the present invention comprises metal and/or metal oxide particles whose average diameter is 0.001 to 0.1 μm.

The metal and/or metal oxide may be selected from copper, nickel, silver, aluminum, iron, cobalt, copper oxides, aluminum oxides, titanium oxides, manganese oxides and iron oxides and their mixtures. Among the above metals and metal oxides, copper, copper oxides, aluminum oxides and titanium oxides are preferred for their excellent property in increasing thermal conductivity of heat transfer media.

The metals and metal oxides particles for the invention may be prepared by evaporation condensation method where metal is evaporated by heat and condensed in the gas or by vapor-phase reaction method where metal compounds are thermally degraded in vapor-phase and allowed to react with oxygen to give metal oxide fine particles.

Metal and metal oxide particles whose average diameter is 0.001 to 0.1 μm are used in the composition of the present invention because such sized particles provide excellent dispersion properties. More preferably, particles whose average diameter is 0.001 to 0.05 μm are used.

Preferably, the metal and/or metal oxide are included in the range from 0.01-20% by weight.

The composition of the present invention further comprises polyphosphonic acid having at least three phosphono groups per molecule and/or salts thereof. The polyphosphonic acid preferably has a structure where a phosphonomethyl group or groups are bonded to a nitrogen atom. The polyphosphonic acid having such a structure may be selected from amino trimethylenephosphonic acid, ethylenediaminetetramethylenephosphonic acid, 2-hydroxy-1,3-propylenediamine-N,N,N⁻,N⁻-tetramethylenephosphonic acid, hexamethylenediaminetetramethylenephosphonic acid, polyaminopolyethermethylenephosphonic acid, diethylenetriaminepentamethylenephosphonic acid, hexamethylenetriaminepentamethylenephosphonic acid, triethylenetetraaminehexamethylenephosphonic acid, 1,4,7,10-tetraazacyclododecane-1,4,7,10-tetramethylene phosphonic acid, their salts (particularly alkali metal salts), and their blends.

Among the polyphosphonic acids and their salts, aminotrimethylenephosphonic acid and/or salts thereof, in particular, alkali metal salts, preferably sodium salt and potassium salt, are preferred to effectively prevent reaction between component (a) and component (c) of the composition.

Preferably, the polyphosphonic acid and/or salts thereof are included in the composition in the range from 0.01 to 20% by weight.

The composition of the invention further comprises a corrosion inhibitor to inhibit corrosion of metal parts used in internal combustion engines, electric motors, hot water supplying systems, heating systems, cooling systems, freezing systems and snow melting systems and road heating systems where the composition is used in heat media therefor.

The metal corrosion inhibitor may be selected from phosphoric acid and salts thereof, aliphatic carboxylic acid and salts thereof, aromatic carboxylic acid and salts thereof, triazole, thiazole, silicate, nitrate, nitrite, borate, molybdate and amine salt.

The phosphoric acid and salts thereof may be orthophosphoric acid, pyrophosphoric acid, hexamethaphosphoric acid, tripolyphosphoric acid and their alkali metal salts. Sodium salt and potassium salt are preferred.

The aliphatic carboxylic acid and salts thereof may be selected from pentanoic acid, hexanoic acid, heptanoic acid, octanoic acid, nonanoic acid, decanoic acid, 2-ethyl hexanoic acid, adipic acid, suberic acid, azelaic acid sebacic acid, undecanoic acid, dodecanedioic acid and their alkali metal salts. Sodium salt and potassium salt are preferred.

The aromatic carboxylic acid and salts thereof may be selected from benzoic acid, toluic acid, paratertiary butylbenzoic acid, phthalic acid, paramethoxybenzoic acid, cinnamic acid and their alkali metal salts. Sodium salt or potassium salt are preferred.

The triazole may be selected from benzotriazole, methylbenzotriazole, cyclobenzotriazole, and 4-phenyl-1,2,3-triazole.

The thiazole may be selected from mercaptobenzothiazole and alkali metal salts thereof. Sodium salt or potassium salt are preferred.

The silicate may be selected from sodium salt and potassium salt of metasilicic acid, and aqueous solutions of sodium silicate represented by Na₂O/XSiO₂ (X: 0.5 to 3.3) called water glass. The nitrate may be selected from sodium nitrate and potassium nitrate and the nitrite may be selected from sodium nitrite and potassium nitrite. The borate may be selected from sodium tetraborate and potassium tetraborate.

The molybdate may be selected from sodium molybdate, potassium molybdate and ammonium molybdate, and the amine salt is selected from monoethanolamine, diethanolamine, triethanolamine, monoisopropanolamine, diisopropanolamine and triisopropanolamine.

Metal materials such as iron, aluminum, copper and their alloys are used in internal combustion engines and others mentioned above. Accordingly, it is advantageous to blend those metal corrosion inhibitors in order to effectively inhibit corrosion of those metal parts.

The composition may additionally comprise a pH adjustor such as sodium hydroxide or potassium hydroxide, antifoaming agent and/or coloring agent in an amount that does not adversely affect the thermal conductivity of heat media.

### EMBODIMENT

Three embodiments of the present invention are described below in comparison with three conventional comparatives.

Table 1 shows the ingredients of Embodiments 1 to 3 and Comparatives 1 to 3. Embodiments 1 to 3 include the compositions of the present invention. The pH value of each Embodiment was adjusted with potassium hydroxide to pH 6 to 11.

Comparatives 1 to 3 do not contain polyphosphonic acid or salt thereof. Comparative 3 does not contain metal or metal oxide particles. The pH value of each comparative was adjusted with potassium hydroxide to pH 6 to 11.

TABLE 1

| Ingredient | Embodiment 1 | Embodiment 2 | Embodiment 3 | Comparative 1 | Comparative 2 | Comparative 3 |
|---|---|---|---|---|---|---|
| Water | Rest | <- | <- | <- | <- | <- |
| Ethylene glycol | 48.0 | 48.0 | — | 48.0 | 48.0 | 48.0 |
| Propylene glycol | — | — | 48.0 | — | — | — |
| Aluminum oxide A (*1) | 10.0 | 10.0 | — | 10.0 | 10.0 | — |
| Copper oxide (*2) | — | — | 10.0 | — | — | — |
| Aminotrimethylenephosphonic | 2.0 | 2.0 | 2.0 | — | — | 2.0 |
| acid | | | | | | |
| Orthophosphoric acid | 0.3 | — | 1.0 | 0.3 | 2.0 | 0.3 |
| Sodium benzoate | — | — | 3.0 | — | — | — |
| Methylbenzotriazole | 0.3 | 0.3 | 0.5 | 0.3 | 0.3 | 0.3 |
| Paratertiary butylbenzoic | 2.0 | — | — | 2.0 | — | 2.0 |
| acid | | | | | | |
| 2-ethylhexanoic acid | — | 3.0 | — | — | 3.0 | — |
| Sebacic acid | 2.0 | 1.0 | — | 2.0 | 1.0 | 2.0 |
| Potassium hydroxide | appropriately | <- | <- | <- | <- | <- |
| Total | 100 | 100 | 100 | 100 | 100 | 100 |
| pH value | 8.0 | 8.0 | 8.0 | 8.0 | 8.0 | 8.0 |

(*1) Aluminum oxide particles having average diameter 13 nm prepared by vapor-phase reaction method
(*2) Copper oxide particles having average diameter 17 nm prepared by vapor-phase reaction method

Stability of dispersion was evaluated for each of Embodiments 1 to 3 and Comparatives 1 to 3. Thermal conductivity was also measured for Embodiment 1 and Comparative 3. The stability of dispersion was evaluated from the appearance in twenty-four hours after preparation (left at room temperature). The precipitation was measured by JIS 2503 centrifugal separation method (method of testing aircraft lubricants). The thermal conductivity was measured with the transient hot plane source technique called a hot disc method. The evaluations of the stability of dispersion and the measurements of the thermal conductivity are provided in Table 2.

TABLE 2

| Test Item | Embodiment 1 | Embodiment 2 | Embodiment 3 | Comparative 1 | Comparative 2 | Comparative 3 |
|---|---|---|---|---|---|---|
| Appearance | Uniform | Uniform | Uniform cloudy | Gelled | Gelled | Colorless |
| | whitish | whitish | | | | transparent |
| Precipitation | 0.3 | 0.3 | 0.3 | Unmeasurable | Unmeasurable | 0.0 |
| JIS K 2503 | | | | | | |
| (vol. %) | | | | | | |
| Thermal | 0.53 | — | — | — | — | 0.42 |
| conductivity | | | | | | |
| [W/mK (25° C.)] | | | | | | |

Table 2 shoes that Embodiments 1 and 2 where metal particles of aluminum oxide were blended were both uniform whitish, and that generation of precipitation was as little as 0.3 vol. % as measured by centrifugal separation according to JIS K 2503, proving that uniform dispersion was maintained and excellent dispersion stability was provided in both.

Embodiment 3 where different metal (copper oxide) particles from Embodiments 1 and 2 were blended was uniformly clouded and generation of precipitation was as little as 0.3 vol. % as measured by centrifugal separation according to JIS K 2503, proving that uniform dispersion was maintained and excellent dispersion stability was provided.

Precipitation in each of Embodiments 1 to 3 was as little as 0.3 vol. % even after promotion by centrifugal separation. Accordingly, it is expected that uniform dispersion can be maintained for an extended period of time such as one to three years.

On the other hand, Comparatives 1 and 2 where aminotrimethylenephosphonic acid, was not contained were immediately gelled and it was not possible to measure the precipitation.

The thermal conductivities of Embodiment 1 and Comparative 3 indicate that Embodiment 1 had a 20% higher thermal conductivity than that of the Comparative 3.

### INDUSTRIAL APPLICABILITY

The heat transfer medium composition of the present invention can be used in coolant for internal combustion engines and motors, in heat media for hot water supplying, heating, cooling and freezing systems, and in heat media for snow melting or road heating systems.

1. A heat transfer medium composition whose main component is selected from water, alcohol, glycol and glycol ether, further comprising:
(a) one kind or two or more kinds selected from metal and/or metal oxide particles whose average diameter is 0.001 to 0.1 μm;
(b) at least one kind of polyphosphonic acid having at least three phosphono groups per molecule and/or salts thereof; and
(c) at least one kind of metal corrosion inhibitor.

2. The heat transfer medium composition according to claim 1, wherein the glycol is ethylene glycol and/or propylene glycol.

3. The heat transfer medium composition according to claim 1, wherein the metal and/or metal oxide particles is selected from particles of copper, copper oxide, aluminum oxide and titanium oxide.

4. The heat transfer medium composition according to claim 3, wherein the metal and/or metal oxide particles is an aluminum oxide, which is contained at 0.01 to 20% by weight.

5. The heat transfer medium composition according to claim 1, wherein the polyphosphonic acid has a structure where a phosphonomethyl group is bonded to a nitrogen atom.

6. The heat transfer medium composition according to claim 1, the polyphosphonic acid having a structure where a phosphonomethyl group is bonded to a nitrogen atom and/or salts thereof are at least one of amino trimethylenephosphonic acid, ethylenediaminetetramethylenephosphonic acid, 2-hydroxy-1,3-propylenediamine-N,N,N⁻,N⁻-tetramethylenephosphonic acid, hexamethylenediaminetetramethylenephosphonic acid, polyaminopolyethermethylenephosphonic acid, diethylenetriaminepentamethylenephosphonic acid, hexamethylenetriaminepentamethylenephosphonic acid, triethylenetetraaminehexamethylenephosphonic acid, 1,4,7,10-tetraazacyclododecane-1,4,7,10-tetramethylene phosphonic acid and/or salts thereof.

7. The heat transfer medium composition according to claim 1, wherein the polyphosphonic acid and/or salts thereof is contained at 0.01 to 20% by weight.

8. The heat transfer medium composition according to claim 1, wherein the metal corrosion inhibitor is selected from phosphoric acid and salts thereof, aliphatic carboxylic acid and salts thereof, aromatic carboxylic acid and salts thereof, triazole, thiazole, silicate, nitrate, nitrite, borate, molybdate and amine salt.

9. The heat transfer medium composition according to claim 2, wherein the metal corrosion inhibitor is selected from phosphoric acid and salts thereof, aliphatic carboxylic acid and salts thereof, aromatic carboxylic acid and salts thereof, triazole, thiazole, silicate, nitrate, nitrite, borate, molybdate and amine salt.

10. The heat transfer medium composition according to claim 3, wherein the metal corrosion inhibitor is selected from phosphoric acid and salts thereof, aliphatic carboxylic acid and salts thereof, aromatic carboxylic acid and salts thereof, triazole, thiazole, silicate, nitrate, nitrite, borate, molybdate and amine salt.

11. The heat transfer medium composition according to claim 4, wherein the metal corrosion inhibitor is selected from phosphoric acid and salts thereof, aliphatic carboxylic acid and salts thereof, aromatic carboxylic acid and salts thereof, triazole, thiazole, silicate, nitrate, nitrite, borate, molybdate and amine salt.

12. The heat transfer medium composition according to claim 5, wherein the metal corrosion inhibitor is selected from phosphoric acid and salts thereof, aliphatic carboxylic acid and salts thereof, aromatic carboxylic acid and salts thereof, triazole, thiazole, silicate, nitrate, nitrite, borate, molybdate and amine salt.

13. The heat transfer medium composition according to claim 6, wherein the metal corrosion inhibitor is selected from phosphoric acid and salts thereof, aliphatic carboxylic acid and salts thereof, aromatic carboxylic acid and salts thereof, triazole, thiazole, silicate, nitrate, nitrite, borate, molybdate and amine salt.

14. The heat transfer medium composition according to claim 7, wherein the metal corrosion inhibitor is selected from phosphoric acid and salts thereof, aliphatic carboxylic acid and salts thereof, aromatic carboxylic acid and salts thereof, triazole, thiazole, silicate, nitrate, nitrite, borate, molybdate and amine salt.
